(19) United States
(12) Patent Application Publication
(10) Pub. No.: US 2024/0062530 A1
(43) Pub. Date: Feb. 22, 2024

(54) DEEP PERCEPTUAL IMAGE ENHANCEMENT

(71) Applicants: Trustees of Tufts College, Medford, MA (US); Research Foundation of the City University of New York, New York, NY (US)

(72) Inventors: Karen A. Panetta, Rockport, MA (US); Shreyas Kamath Kalasa Mohandas, Burlington, MA (US); Shishir Paramathma Rao, Burlington, MA (US); Srijith Rajeev, Burlington, MA (US); Rahul Rajendran, Belleville, MI (US); Sos S. Agaian, New York, NY (US)

(73) Assignees: Trustees of Tufts College, Medford, MA (US); Research Foundation of the City University of New York, New York, NY (US)

(21) Appl. No.: 18/256,975

(22) PCT Filed: Dec. 17, 2021
(86) PCT No.: PCT/US2021/063999

§ 371 Date: Jun. 12, 2023

Related U.S. Application Data
(60) Provisional application No. 63/127,130, filed on Dec. 17, 2020.
(60) Provisional application No. 63/201,025, filed on Apr. 8, 2021.

(51) Int. Cl. G06V 10/776; G06T 5/00; G06T 5/50; G06V 10/60; G06V 10/77; G06V 10/774; G06V 10/82

(52) U.S. Cl. CPC G06V 10/776; G06T 5/001; G06T 5/50; G06V 10/60; G06V 10/7715; G06V 10/774; G06V 10/82; G06T 2207/20081; G06T 2207/20084; G06T 2207/20212

(57) ABSTRACT

A system for training a neural network includes a neural network configured to receive a training input in an image space and produce an enhanced image. The system further includes an error signal generator configured to compare the enhanced image to a ground truth and generate an error signal that is communicated back to the neural network to train the neural network. Additionally, the system includes a neural input enhancer configured to modify the training input in response to receiving at least one of an output from the neural network or the error signal. Modifying the training input improves one of an efficiency or a training result of the neural network beyond the communication of the error signal to only the neural network.

### CROSS-REFERENCE TO RELATED APPLICATIONS

The present application claims the benefit of U.S. Provisional Patent Application No. 63/127,130, filed on Dec. 17, 2020, and U.S. Provisional Patent Application No. 63/201,025, filed don Apr. 8, 2021, both of which are incorporated herein by reference.

### BACKGROUND

Images and videos may capture a vast amount of rich, detailed, and useful information about a scene. Intelligent systems may use these captured images for various computer vision tasks like image enhancement, object detection, classification and recognition, segmentation, three-dimensional scene understanding, and modeling. These vision tasks form the building block for real-world applications such as autonomous driving, security surveillance systems, search and rescue operations, and virtual and augmented reality environments, among other things.

Images and videos may also be enhanced, such that humans (i.e., using unaided human vision) can experience increased viewing enjoyment, and/or find the images and videos easier to use within human visions tasks. Human vision tasks can include, for example: finding, identifying, labeling, categorizing, locating within a scene, and tracking objects or features in images or videos. The quality of images can become extremely important for people, machines, and for combinations of people and machines performing these real-world applications.

### SUMMARY

Embodiments of the present disclosure provide methods and apparatus for training a neural network. An example system may include a neural network configured to receive a training input in an image space and produce an enhanced image. The system may include an error signal generator configured to compare the enhanced image to a ground truth and generate an error signal that is communicated back to the neural network to train the neural network. The system may include a neural input enhancer configured to modify the training input in response to receiving at least one of an output from the neural network or the error signal. Modifying the training input improves one of an efficiency or a training result of the neural network beyond the communication of the error signal to only the neural network.

In one aspect, a system for training a neural network, the system comprises: a neural network configured to receive a training input in an image space and produce an enhanced image; an error signal generator configured to compare the enhanced image to a ground truth and generate an error signal that is communicated back to the neural network to train the neural network; and a neural input enhancer configured to modify the training input in response to receiving at least one of an output from the neural network or the error signal, wherein modifying the training input improves one of an efficiency or a training result of the neural network beyond the communication of the error signal to only the neural network.

A system may include one or more of the following features: the neural input enhancer receives the output from the neural network, the output associated with updated parameters within the neural network, the neural input enhancer receives the error signal, the neural input enhancer configured to modify the training input independently of updated parameters within the neural network, the output from the neural network is determined via reverse sequential calculation and storage of gradients of intermediate variables and parameters within the neural network, the error signal generator is configured to generate the error signal based on illuminance and reflectance components of the training input, the error signal provides equal weight to the illuminance and reflectance components of the training input, the error signal generator is configured to generate the error signal in the image space, and/or the neural network is configured to produce the enhanced image in a feature space.

In another aspect, a method of training a system for image enhancement comprises: providing a training input to a neural network via a neural input enhancer; generating an enhanced image from the training input; comparing the enhanced image to a ground truth and generating an error signal; providing the error signal to the neural network; receiving, at the neural input enhancer, at least one of an output from the neural network or the error signal; and modifying the training input based on the at least one of the output from the neural network or the error signal, wherein modifying the training input improves one of an efficiency or a training result of the neural network beyond communication of the error signal to only the neural network.

A method may include one or more of the following features: modifying the training input occurs in an image space, generating the enhanced image occurs in a feature space, generating the error signal comprises determining illuminance and reflectance components of the training input, the error signal provides equal weight to the illuminance and reflectance components of the training input, generating the output from the neural network by: performing a reverse sequential calculation for the neural network; and storing gradients of intermediate variables and parameters within the neural network, the neural input enhancer receives the output from the neural network, the output associated with updated parameters within the neural network, modifying the training input independently of updating parameters within the neural network.

In a further aspect, a method of enhancing images comprises: receiving an input image; adjusting an exposure range of the image, including synthetically changing exposures of brighter and darker regions of the image to generate an exposure-adjusted image; determining discriminative features for the exposure-adjusted image; and combining the discriminative features to generate an enhanced image.

A method may further include one or more of the following features: applying a loss function to the enhanced image to generate a perceptually enhanced image, wherein the loss function processes illuminance and reflectance components of the enhanced image, adjusting the exposure range of the image comprises logarithmic exposure transformation (LXT) processing, synthetically changing exposures of brighter and darker regions of the image includes generating synthetic images having under-exposed images with bright regions that are well-defined with contrast, and over-exposed images with finer details in dark and shadow areas highlighted, the discriminative features define a portion of information about the exposure-adjusted image and an entirety of the exposure-adjusted image, integrating first ones of the discriminative features to determine a type of scene, subjects in the scene, and/or lighting conditions, and second ones of the discriminative features represent local texture or object at a given location in the exposure-adjusted image, employing a feature condense network and a feature enhance network to determine the local and global features, the feature condense network and the feature enhance network generate feature maps having channels, and further including assigning different values to different ones of the channels according to convolution layer interdependencies, the illumination component defines global deviations in the enhanced image and the reflectance component represents details and colors of the enhanced image, and/or the illumination component and the reflectance components are equally weighted.

In a further aspect, a system comprises: a processor and a memory configured to: receive an input image; adjust an exposure range of the image, including synthetically changing exposures of brighter and darker regions of the image to generate an exposure-adjusted image; determine discriminative features for the exposure-adjusted image; and combine the discriminative features to generate an enhanced image.

A system may further include one or more of the following features: the processor and the memory are further configured to apply a loss function to the enhanced image to generate a perceptually enhanced image, wherein the loss function processes illuminance and reflectance components of the enhanced image, adjusting the exposure range of the image comprises logarithmic exposure transformation (LXT) processing, synthetically changing exposures of brighter and darker regions of the image includes generating synthetic images having under-exposed images with bright regions that are well-defined with contrast, and over-exposed images with finer details in dark and shadow areas highlighted, the discriminative features define a portion of information about the exposure-adjusted image and an entirety of the exposure-adjusted image, the processor and the memory are further configured to integrate first ones of the discriminative features to determine a type of scene, subjects in the scene, and/or lighting conditions, and second ones of the discriminative features represent local texture or object at a given location in the exposure-adjusted image, the processor and the memory are further configured to employing a feature condense network and a feature enhance network to determine the discriminative features, the feature condense network and the feature enhance network generate feature maps having channels, and further including assigning different values to different ones of the channels according to convolution layer interdependencies, the illumination component defines global deviations in the enhanced image and the reflectance component represents details and colors of the enhanced image, and/or the illumination component and the reflectance components are equally weighted.

### BRIEF DESCRIPTION OF THE DRAWINGS

The present disclosure will hereafter be described with reference to the accompanying drawings, wherein like reference numerals denote like elements.

FIG. 1 is a schematic diagram of a prior art neural network system;

FIG. 2 is a schematic diagram of an image processing system, according to an embodiment of the present disclosure;

FIG. 3 is a detailed schematic diagram of the image processing system of FIG. 2, according to an embodiment of the present disclosure;

FIG. 4 is a detailed schematic diagram of the image processing system of FIG. 2, according to another embodiment of the present disclosure;

FIG. 5 is an example system for implementing image processing methods, according to an embodiment of the present disclosure;

FIG. 6A is diagram of a network architecture, according to an embodiment of the present disclosure;

FIG. 6B is a diagram of a residual network of the network architecture of FIG. 6A, according to an embodiment of the present disclosure;

FIG. 6C is a diagram of another residual network of the network architecture of FIG. 6A, according to an embodiment of the present disclosure;

FIG. 7A is an example diagram illustrating a logarithmic exposure transformation (LXT) operation, according to an embodiment of the present disclosure;

FIG. 7B is a graph of logarithmic exposure transformation (LXT) values based on intensity, according to an embodiment of the present disclosure;

FIG. 7C is another graph of LXT values based on intensity, according to an embodiment of the present disclosure;

FIG. 8A is a diagram illustrating layers of a feature condense network and a feature enhance network, according to an embodiment of the present disclosure;

FIG. 8B is a table of feature condense network parameters corresponding to FIG. 8A, according to an embodiment of the present disclosure;

FIG. 9 is a table comparing output values from various systems, according to an embodiment of the present disclosure;

FIG. 10 is an example diagram comparing output images from various systems, according to an embodiment of the present disclosure;

FIG. 11 is an example diagram comparing output images from various systems, according to an embodiment of the present disclosure;

FIG. 12 is an example diagram comparing output values from various systems, according to an embodiment of the present disclosure;

FIG. 13 is a table comparing output images from various systems, according to an embodiment of the present disclosure;

FIG. 14 is an example diagram comparing output images from various systems, according to an embodiment of the present disclosure;

FIG. 15 is an example diagram comparing output images from various systems, according to an embodiment of the present disclosure;

FIG. 16 is an example diagram comparing output images from various systems, according to an embodiment of the present disclosure;

FIG. 17 is an example diagram comparing output images from various systems, according to an embodiment of the present disclosure;

FIG. 18 is an example diagram comparing output images from various systems, according to an embodiment of the present disclosure;

FIG. 19 is an example diagram comparing output images from various systems, according to an embodiment of the present disclosure; and

FIG. 20 is an example diagram comparing output images from various systems, according to an embodiment of the present disclosure.

### DETAILED DESCRIPTION

Before embodiments of the disclosure are described in detail below, it is to be understood that the claimed invention is not limited to the particular aspects described. It is also to be understood that the terminology used herein is for the purpose of describing example embodiments of the disclosure and is not intended to be limiting in any way.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Aspects referenced as “comprising”, “including”, or “having” certain elements are also contemplated as “consisting essentially of” and “consisting of” those elements unless the context clearly dictates otherwise. It should be appreciated that aspects of the disclosure that are described with respect to a system are applicable to the methods, and vice versa, unless the context explicitly dictates otherwise. Furthermore, the words “can” and “may” are used throughout this application in a permissive sense (i.e., having the potential to, being able to), not in a mandatory sense (i.e., must).

Aspects of the present disclosure are explained in greater detail in the description that follows. Aspects of the disclosure that are described with respect to a method are applicable to aspects related to systems and other methods of the disclosure, unless the context clearly dictates otherwise. Similarly, aspects of the disclosure that are described with respect to a system are applicable to aspects related to methods and other systems of the disclosure, unless the context clearly dictates otherwise. As used herein, the terms “perception” and “perceptual” may generally refer to human perception and/or machine perception, and can include the concepts of finding, identifying, labeling, categorizing, locating within a scene, and tracking. Additionally, in the context of artificial intelligence (AI) and machine learning (ML) systems, image enhancement (as provided by the present systems and methods) demonstrates improved accuracy with less training data and/or less curation/annotation of the training data. Thus, the enhanced images result in a simpler, less complex training/optimizing process for a neural network.

In the drawings, similar symbols typically identify similar components, unless context dictates otherwise. The numerous innovative teachings of the present invention will be described with particular reference to several embodiments (by way of example, and not of limitation). It will be readily understood that the aspects of the present disclosure, as generally described herein, and illustrated in the Figures, can be arranged, substituted, combined, separated, and designed in a wide variety of different configurations, all of which are explicitly contemplated herein.

As mentioned above, image quality can be important for many applications (e.g., security, automated driving, and augmented reality), such that real-world systems, including i) the AI/ML systems which train the deployed machine vision systems, ii) entirely automated systems, and iii) systems which include a combination of a human and a machine vision system, may experience decreased performance when provided with low-quality image inputs. Acquiring high or optimum quality images is ideal, but often impractical. As an example, smartphone cameras have considerably small apertures, limiting the amount of light captured, and leading to noisy images in a low-lit environment. Further, the linear characteristic of the imaging sensor fails to replicate the complex and nonlinear mapping achieved by human vision.

Another issue that commonly restricts the performance of computer vision algorithms is non-uniform illumination. When the source of lighting is not perfectly aligned and/or normal to the viewing surface, or if the surface is not planar, then the resulting image may have non-uniform illumination artifacts. Another imaging aspect for efficient image processing is global uniformity. Similar objects or structures should generally appear the same within an image or in a series of images. This implies that the color content and the illumination must be stable for images acquired under varying conditions.

Illuminations that cast strong shadows can also cause problems. The edges and boundaries in an image should be well-defined and accurately located. This implies that the high-frequency content of the images needs to be preserved to have high local sensitivity. Vignetting is another common pitfall in many images. While it might be a desirable effect in some cases like portrait-mode photography, it is not ideal for various other use cases that require high accuracy and detail. Additionally, compression algorithms used to store images may cause artifacts.

The above-mentioned factors are examples that not only affect the “pleasantness” of viewing the image, but also affect the usability of the images for computer vision algorithms (both in training and in operation) and the ability of such algorithms to perform analysis, including when deployed in machine vision systems. Given the importance of image and video to a wide variety of applications, from pure aesthetic appreciation to security/surveillance, there is a need for improved approaches to image enhancement.

Automatic image quality enhancement methods can be broadly classified into two categories: global enhancements and local enhancements. Global enhancement algorithms perform the same operation on every single image pixel, such as linear contrast amplification. Such a simple technique leads to saturated pixels in high exposure regions. To avoid this effect, nonlinear monotonic functions such as mu-law, power-law, logarithmic processing, gamma functions, and piecewise-linear transformation functions are used to perform enhancements. One extensively used method to avoid saturation, while improving the contrast, is histogram equalization (HE). Another approach to enhance images is based on local image enhancement algorithms like the Retinex theory, which assumes that the amount of light reaching the observer can be decomposed into two parts: scene reflectance and illumination components. These algorithms achieve better results when compared to global methods, by making use of the local spatial information directly. However, while methods based on Retinex such as multi-scale Retinex with color restoration (MSR-CR) can effectively improve the sharpness of the image and increase the local contrast, they introduce halation phenomenon at high contrast regions and amplified noise regions.

More recently, methods based on deep learning for image enhancement have attempted to target some of these problems. These techniques allow for automatic parameter selection and training, while also having highly-scalable architectures. In some instances, these deep learning methods have shown to outperform prior methods in computer vision tasks, such as object detection, object recognition, segmentation, super-resolution, and enhancement. Of course, these deep learning methods are generally understood to be limited by training and design. For example, these deep learning networks are generally trained explicitly for either standard exposure images or low exposure images, and thus fail to achieve global uniformity for varying exposure inputs of the same scene.

The systems and methods of image enhancement disclosed herein address the above-mentioned challenges, as well as others. Specifically, the present disclosure includes embodiments of a deep learning-based perceptual image enhancement network (DPIENet), which is described in detail below. In some embodiments, the DPIENet can include a neural input enhancer (NIE).

In some embodiments, DPIENet-based systems and methods can include a unified network that can ensure global uniformity by generating perceptually similar enhanced images for input images of both standard and low exposure settings. Further, the systems and methods can include a combination of a classical log-based synthetic multi-exposure image generation technique with trainable parameters, which can improve the performance of the network. In some configurations, the systems and methods can include utilization of dilated convolutions tailored for image enhancement techniques, which can preserve spatial resolution in convolutional networks and improve spatially detailed image understanding. Further, extraction of global features from each internal block of the condense network, along with the last block, can capture the notion of scene-setting, global lighting condition, or even subject types, and to determine the kind of local operations to be performed.

In some configurations, a channel attention mechanism can be tailored to the image enhancement technique, and that aims at adaptively rescaling channel-wise features by extracting the channel statistics. The channel attention mechanism can further enhance the discriminative ability of the network.

The present systems and methods can include a loss function (e.g., a “multi-scale human vision loss”). This loss function can improve image reconstruction quality by considering human perception, and enhancing the desired characteristics by using reflectance and illumination components. Specifically, the loss function can be configured to promote the model to learn complicated mappings and effectively reduce the undesired artifacts such as noise, unrealistic color or texture distortions, and halo effects.

The presently disclosed systems and methods can be implemented in a wide variety of real-world applications. In biometric multimedia data applications (such as fingerprint or palm print matching), image analytic techniques may be used to improve recognition systems. In biomedical images, detection of physiological abnormalities may lead to improved diagnoses. Vehicle navigation systems use image and/or video analytics to detect lane markings and improve visualization during various weather conditions. Other analytics applications include, but are not limited to, facial detection, feature detection, quality analysis in food industry, remote sensing, and defense surveillance. Analytic systems can be crucial for mobile biometrics, for document image analysis (identification), and for visual sensor networks and big data applications, including social/personal media applications. For example, using visual sensor networks, various types of cameras may provide diverse views of a scene, which can enhance the consistency of and help provide a better understanding of the captured events/actions. Other applications include medical or dental applications, pathogen or material recognition, or even topographic or oceanic analysis. There is no a priori requirement that the sensors used to generate the images must detect wavelengths visible to the unaided human eye.

Generally, embodiments of the present disclosure relate to systems and methods for multimedia processing. Such multimedia may include, but is not limited to, any form of visible, near visible, thermal, grayscale, color, thermal, biometric, and/or biomedical imaging, and/or video, figure, and/or text. While the following description may generally refer to images, the methods and systems described herein may be applicable to any type of multimedia content (e.g., images, videos, figures, and/or text). Thus, by way of example, any method steps described herein as using images may instead use videos, figures, and/or text.

As used herein, the term “image space” generally indicates that the data being processed corresponds to an image (e.g., a color/RGB image, a grayscale image). Additionally, as used herein, the term “feature space” generally indicates that the data being processed corresponds to a feature (e.g., edges, textures, shapes, various other lower and higher-level features). The features may be generated by the network. In some instances, the features may not be in a format that is conducive for human visual perception.

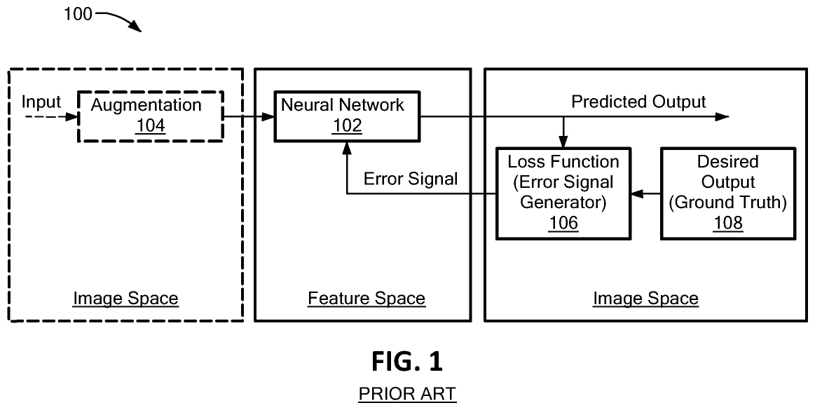

Referring now to FIG. 1, a schematic diagram of a conventional neural network system (NNS) 100 is shown. Generally, in a conventional neural network, an error function is propagated through the neural network, updating the various filters that are within. This process is commonly referred to as “training.”

As shown in FIG. 1, the NNS 100 can include processes in both the feature space and image space. The NNS 100 includes a neural network 102, which receives an input, and provides a predicted output. The predicted output can be provided to a loss function (i.e., an error signal generator) 106. The loss function 106 can additionally receive data corresponding to a desired output (i.e., ground truth) 108. The loss function 106 is configured to process the predicted output and the desired output 108 to generate an error signal. As shown, the error signal is fed back to the neural network 102. As mentioned above, the error signal is then used to update the various filters within the neural network 102.

In some neural network systems (e.g., NNS 100), augmentation 104 is performed using the system input. The augmented input is then provided to the neural network 102 (as opposed to the input directly). As shown, the augmentation 104 can occur within the image space. The technique of augmentation is a static process. Meaning, the transformation and the parameters are fixed. Augmentation 104 is merely a process of handling a shortage of data and/or imbalance within the data. Accordingly, there are no learning elements in augmentation 104.

The present disclosure includes systems and methods for a deep perceptual image enhancement network (DPIENet) and can use a function to obtain an enhanced image. The present disclosure addresses existing image-to-image translation problems and transforms an input image to an enhanced output image with desired characteristics. As an example, the input image may include color rendition, ill exposure, unrealistic color issues, and/or have been created using wavelengths not normally visible to the unaided human eye.

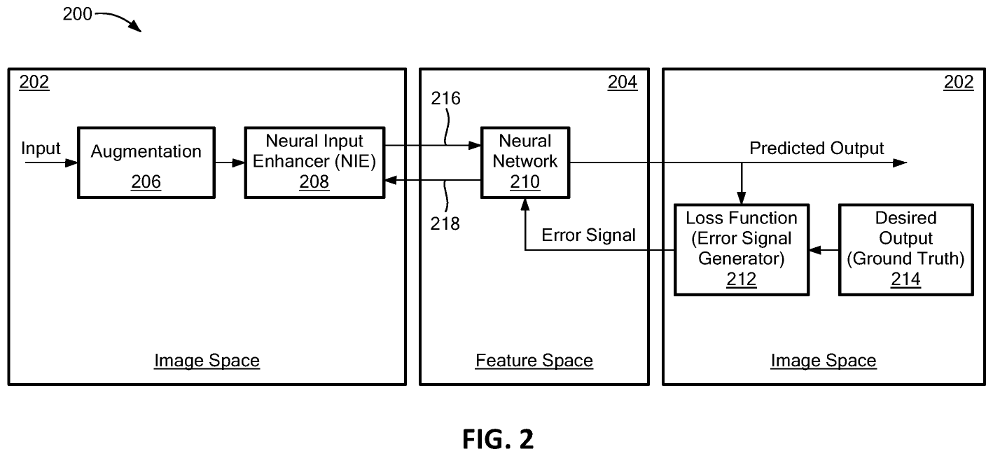

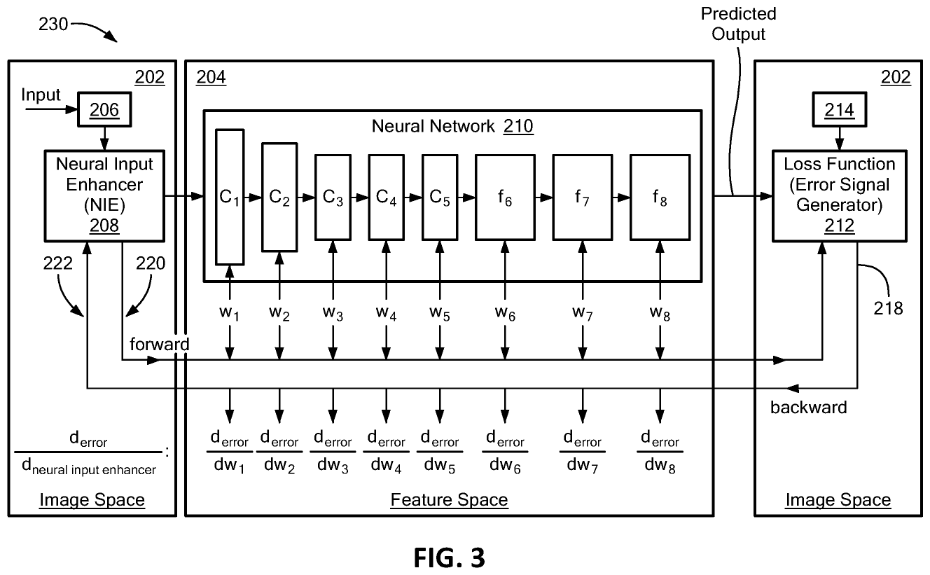

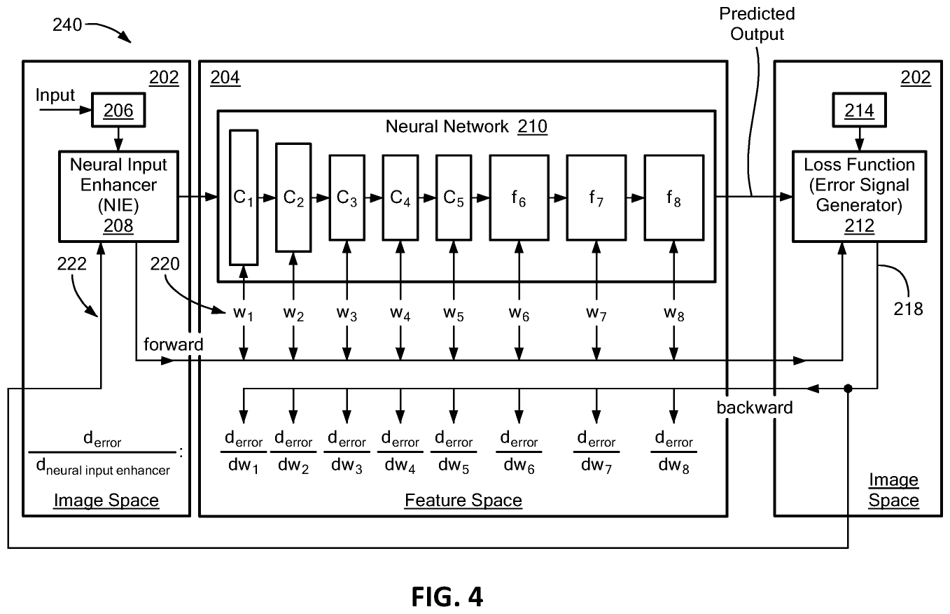

Referring now to FIGS. 2-4, schematic diagrams of image processing systems are shown, according to embodiments of the present disclosure. More particularly, FIGS. 2-4 include schematic diagrams of systems that can be used to train a neural network or deep learning network to produce enhanced images. FIGS. 3 and 4 provide detailed, example configurations in accordance with the system 200 shown by FIG. 2. System 200 is shown to include several processes that occur within an image space 202 and a feature space 204. In particular, an augmentation module 206, neural input enhancer (NIE) 208, loss function module 212, and a desired output module 214 can correspond to the image space 202. A neural network 210 can correspond to the feature space 204.

The system 200 includes the neural network 210, which is illustrated in a training construct in accordance with the present disclosure. The neural network 210 receives an input and provides a predicted output. The predicted output can be provided to the loss function (i.e., an error signal generator) 212. The loss function 212 can additionally receive data corresponding to the desired output (i.e., ground truth) 214. The loss function 212 can be configured to process the predicted output and the desired output 214 to generate an error signal. As shown, the error signal is fed back to the neural network 210. The error signal can be used to update or otherwise train the neural network 210 to produce a predicted output that aligns with the ground truth.

The system 200 is shown to include the augmentation module 206, which can perform augmentation on the system input. As discussed, the technique of augmentation is a static process. Accordingly, there are no learning elements within augmentation module 206. Notably, in contrast to the conventional neural network 102, the system 200 includes the NIE 208. In some configurations, the augmented input can be provided to the NIE 208, instead of the neural network 210. Accordingly, the NIE 208 can be configured to communicate with the neural network 210. As shown, the NIE 208 can provide an input 216 to the neural network 210, and the NIE 208 can receive an output 218 from the neural network 210.

In accordance with the present disclosure, the NIE 208 is distinct from the augmentation process. Generally, augmentation deals with only increasing data by flipping and rotating images, among other things. In contrast, the NIE 208 can be configured to perform transformations that improve the learning of the neural network 210 (e.g., depending on the requirements of the ground truth 214 that is propagated through the error signal). The present disclosure provides a connection between the NIE 208 and the neural network 210, such that the NIE 208 can receive feedback from the neural network 218, for example, such as the output. The output 218 enables training the parameters for transforming the images, thus making them dynamic and adaptable to system requirements. FIGS. 3 and 4 provide further detail pertaining to the output 218.

Implementation of a neural input enhancer (e.g., NIE 208) within a neural network system (e.g., system 200) can provide many advantages. As an example, the NIE can decrease the number of additional parameters within the system due to processing within the image space. Further, the NIE can reduce the optimization complexity and load on the network, thereby increasing efficiency. In some configurations, the NIE can be implemented in a variety of deep learning systems (i.e., aside from the image domain), such as audio (one-dimensional) and hyperspectral (multi-dimensional) systems. Although the NIE 208 is described in relation to a deep neural network, utilizing an NIE can produce similar results with shallow networks. The advantages described above are provided as non-exhaustive examples.

Referring now to FIGS. 3 and 4, systems 230 and 240 provide example configurations of the system 200, in accordance with the present disclosure. Both system 230 and 240 can utilize forward propagation (represented by arrows 220) and backward propagation (represented by arrows 222). Generally, forward propagation (or “forward pass”) refers to calculation and storage of intermediate variables (including outputs) for a neural network in order from the input layer to the output layer. Backward propagation generally refers to calculating the gradient of neural network parameters. In short, the backward propagation method traverses a network in reverse order, from the output to the input layer (according to the established mathematical chain rule).

As shown by FIG. 3, system 230 can include backward propagation (222), which traverses through the neural network 210, updating all the weights/parameters (e.g., wₐ), and hence allowing the neural input enhancer 208 to learn what kind of inputs are required for the neural network 210 to achieve higher accuracy. Advantageously, this joint learning procedure reduces the network and computation complexity corresponding to the system 230.

As shown by FIG. 4, system 240 can include a direct connection between the loss function 212 and the neural input enhancer (NIE) 208. Thus, the output of the loss function 212 does not traverse through the neural network 210 before the NIE 208. As shown, the weights/parameters of the neural network 210 and the NIE 208 are optimized separately. In some configurations, the separate optimization can make the system 200 somewhat disjointed, and may require higher computation to achieve the desired accuracy.

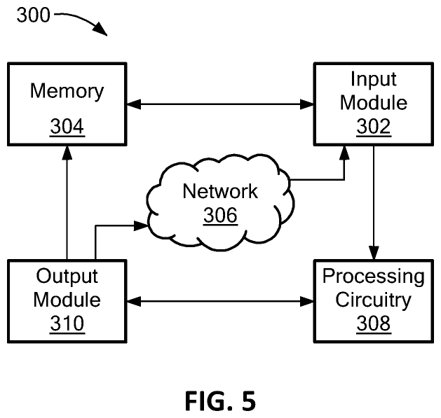

FIG. 5 illustrates a diagram of an example system 300 configured to implement the systems and methods described herein. The system 300 of FIG. 5 can include one or more input modules 302 configured to capture or obtain images and can include processing circuitry 308 configured to execute image analytics using the input images in accordance with the methods described herein. The system 300 can also include a memory 304 configured to store images, image data, and/or templates, in which the input module 302 may retrieve such data from the memory 304 for use by the processing circuitry 308. Additionally, or alternatively, the input module 302 may be configured to access similar data via external memory (e.g., using network 306) or other external storage. Furthermore, the memory 304 or cloud storage may be used to store processed images and/or generated reports (e.g., generated as output from the processing circuitry 308, as further described below).

In some embodiments, the system 300 can be a portable imaging system configured to capture image data. As such, the input module 302 can include one or more sensors (e.g., thermal sensors, 2D visible image sensors, near-infrared sensors) and may be used to create or acquire digital image data. According to one example, the system 300 can be a portable imaging system such as a camera, a cellular telephone, a video camera, or any other imaging device that captures digital image data. In such embodiments, the input module 302 can include a camera module with one or more lenses (not shown) and one or more corresponding image sensors. Additionally, the lens may be part of an array of lenses, and the image sensor may be part of an image sensor array. In some embodiments, the input module 302 can also include its own processing circuitry (not shown) to pre-process acquired images.

In some embodiments, the processing circuitry 308 can include one or more processors configured to carry out one or more method steps described herein. For example, the processing circuitry 308 can include one or more integrated circuits (e.g., image analytic circuits, microprocessors, storage devices such as random-access memory and non-volatile memory, etc.) and can be connected to the input module 302 and/or form part of the input module 302 (e.g., as circuits that form part of an integrated circuit that includes a sensor or an integrated circuit within the input module 302 that is associated with the sensor). Image data that has been captured, or acquired, and processed by the input module 302 can, if desired, be further processed and stored using the processing circuitry 308.

As shown in FIG. 5, the system 300 can also include an output module 310 in communication with the processing circuitry 308. The output module 310 can be, for example, a display configured to display generated reports or processed images created by the processing circuitry 308. Additionally, processed image data (such as visual images and/or generated reports) can also, if desired, be provided to external equipment (not shown), such as a computer or other electronic device, using wired and/or wireless communication paths coupled to the processing circuitry 308. In some applications, output images can be retrieved by the input module 302 of the system 300 and used as input images for additional image analytics (such as any of the methods described herein).

It should be noted that, while the system 300 is shown and described herein, it is within the scope of this disclosure to provide other types of systems to carry out one or more methods of the present disclosure. For example, some embodiments may provide an external image acquisition module as a standalone system. The external acquisition module may be configured to acquire and initially process image data, as described above, then store such data on external storage (such as cloud storage) for use with the system 300 of FIG. 5. Furthermore, in some embodiments, the system 300 may or may not include its own image acquisition module, and is configured to be connected with or coupled to an external acquisition module.

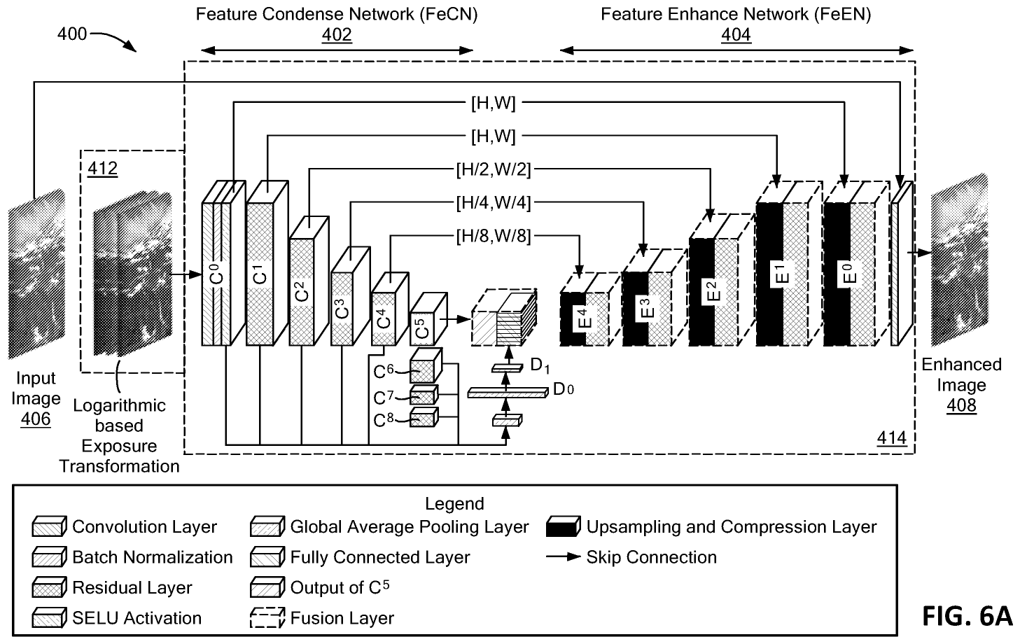

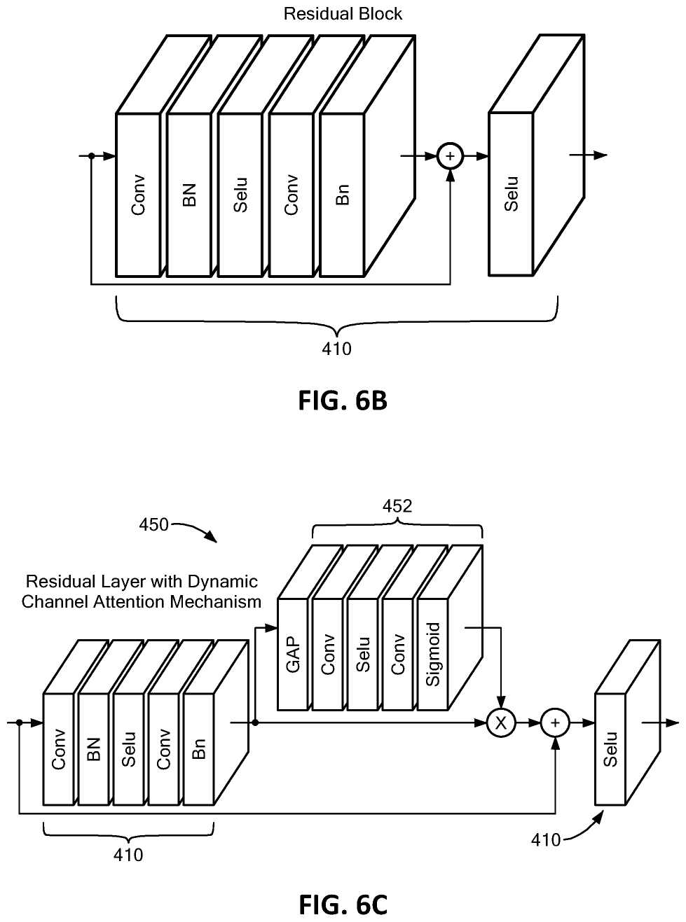

Referring now to FIGS. 6A-6C, a DPIENet system 400 is shown, according to embodiments of the present disclosure. In some configurations, the system 400 can be a specific implementation of system 200. As shown by FIG. 6, the system 400 can include a feature condense network 402 and a feature enhance network 404. An input image 406 can be provided to the feature condense network 402. Once processed, the feature enhance network 404 can output an enhanced image 408. The feature condense network 402 can be configured to acquire compact feature representation of the spatial context of the input image 406. Additionally, the feature enhance network 404 can be configured to perform nonlinear up-sampling of the input image feature maps, to reconstruct an enhanced image. In some configurations, the system 400 can include skip connections between the feature condense network 402 and the feature enhance network 404, such that high-resolution image details can be used during the image reconstruction.

FIG. 6A provides an example illustration of a neural input enhancer (NIE) 412, which can correspond to the NIE 208 as shown within FIGS. 2-4. Similarly, FIG. 6A provides an example illustration of a neural network 414, which can correspond to the neural network 210 as shown within FIGS. 2-4.

FIG. 6B includes a residual block 410, which can be included in the system 400 (e.g., within the feature condense network 402). FIG. 6C includes a modified residual block 450, according to embodiments of the present disclosure. As shown, the modified residual block 450 can include the residual block 410, as well as a dynamic channel attention (DCA) module 452. The DCA module 452 can be configured to emphasize significant features within an image. In some configurations, the modified residual block 450 can be implemented within the neural network 414 (as illustrated by FIG. 6A).

Generally, the DPIENet system 400 can include three components: a neural input enhancer (NIE) (e.g., an LXT: logarithmic-based exposure transformation), joint local and multi-block global feature extraction, and dynamic channel attention blocks. These components can be tightly coupled and trained in an end-to-end process. Each of the three components will be described in detail below.

Referring to the NW (e.g., neural input enhancer 208, 412), the exposure range of the input image may need to be adjusted. This adjustment enables the system 400 to be able to represent a wide range of luminance present in a natural scene, such as bright and direct sunlight to dark and faint shadows. An ideal enhanced image would be able to preserve high-quality details in the shadows while retaining a good contrast in the bright regions. On the contrary, an image with non-uniform scene luminance will have a tradeoff between the bright and dark regions due to the limited exposure and result in loss of data in those regions. To generate a perceptually enhanced image from a single image, synthetic simulation of changes in exposures is required. Specifically, the synthetic images need to have under-exposed images, where the bright regions are well defined with proper contrast, and over-exposed images where the finer details in the dark and shadow areas are highlighted. Consider an input image Î of any arbitrary size (m, n), then the logarithmic-based exposure transformation (LXT) of that image can be generated via Equation 1:

$${I}^{′} = \frac{log \{ 1 ⊕ {α}_{x} ⊗ {\hat{I}}_{{x}_{max}} ⊗ {( {\hat{I}}_{x} ⊗ {\hat{I}}_{{x}_{max}} )}^{{γ}_{x}} \}}{log \{ 1 ⊕ α \}} \vert x = \{ O , U \} \\ {I}_{x} = \{ \begin{matrix}{I}^{′} + v {I}_{y} & , x = O \\ 1 - ( {I}^{′} + v {I}_{y} ) & , x = U\end{matrix} \qquad ( 1 )$$

where Îₓ_{ₘₐₓ} is the maximum intensity; γ_{U}=1.75; γ_{O}=0.75; Î_{U}=Î_{U}_{ₘₐₓ}−Î; Î₀=Î, ⊕, ⊗ and Ø can be any arithmetic, logarithmic operators. As an exemplary case, these operators can be the parametric logarithmic image processing operators. where alpha and gammas are some learnable parameters. Furthermore, I_{y} can be replaced with the following definitions.

| | |
|---|---|
| Local Mean | ${m}_{x} ( i , j ) = \frac{1}{{( 2 n + 1 )}^{2}} {\sum }_{k = i - n}^{i + n} {\sum }_{l = j - n}^{j + n} x ( k , l )$ |
| Local Variance | ${σ}_{x}^{2} ( i , j ) = \frac{1}{{( 2 n + 1 )}^{2}} {\sum }_{k = i - n}^{i + n} {\sum }_{l = j - n}^{j + n} x ( k , l ) - {m}_{x} ( i , j )$ |
| Adaptive Contrast | ACE(i, j) = mₓ(i, j) + G(i, j)x(i, j) − mₓ(i, j) |
| Enhancement | |
| Contrast Gain | CGACE(i, j) = mₓ(i, j) + C(i, j) − mₓ(i, j) |
| Adaptive Contrast | |
| Enhancement | |
| Local Standard Deviation Adaptive Contrast Enhancement | $LSDACE ( i , j ) = {m}_{x} ( i , j ) + \frac{D}{{σ}_{x} ( i , j )} x ( i . j ) - {m}_{x} ( i , j )$ |

Considering x(i,j)to be the gray level value of a specific pixel in an image, a window centered at (i,j) to has a local area defined as (2n+1)×(2n+1) where n is an integer. The local standard deviation (LSD) is simply the square root of the variance and is denoted as σₓ(i,j). The contrast gain (CG) is given by the function G(i,j) and determining its value is the most important step in the adaptive contrast enhancement algorithm (Chang, D. C., & Wu, W. R. (1998). Image contrast enhancement based on a histogram transformation of local standard deviation. IEEE transactions on medical imaging, 17(4), 518-531.). The contrast gain is normally greater than one since the goal of the adaptive contrast enhancement algorithm is to amplify [x(i,j)−mₓ(i,j)] the high frequency component of the image. The simplest method is to set G(i,j) as a constant, C, and let it be greater than one (Narendra, P. M., & Fitch, R. C. (1981). Real-time adaptive contrast enhancement. IEEE transactions on pattern analysis and machine intelligence, (6), 655-661.).

The transform of Equation 1 is derived using companding functions like μ-law and the power law, and it produces under-exposed (U) and over-exposed images (O). In Equation 1, α is a learnable parameter and the γₓ value is empirically set to 1.75 and 0.75 based on the tradeoff between the expansion of underexposed regions and the amount of detail in the overexposed areas. To simulate the over-exposed image I′_{O}, the LXT can map the low-intensity values to a broader range of values while compressing the range of higher intensity values. Conversely, to obtain the under-exposed images I′U, the inverse LXT function can expand the higher intensity regions and compress the range of lower intensities. Different contrast gains can be utilized for different regions by incorporating the local standard deviation of a region. This method is presented as the LSDACE, where D is a constant and the contrast gain is inversely proportional to the local standard deviation and is also spatially adaptive.

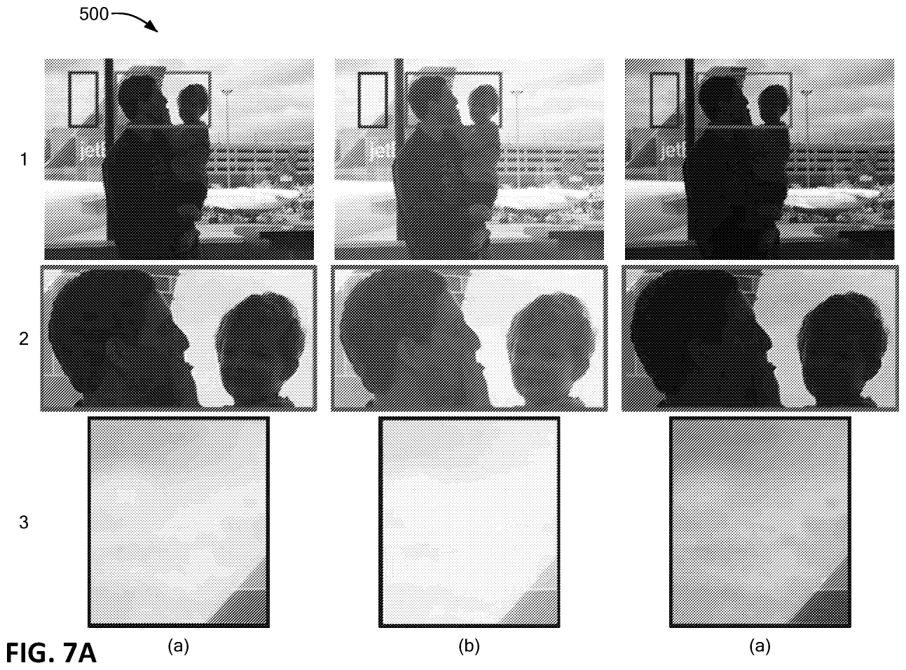

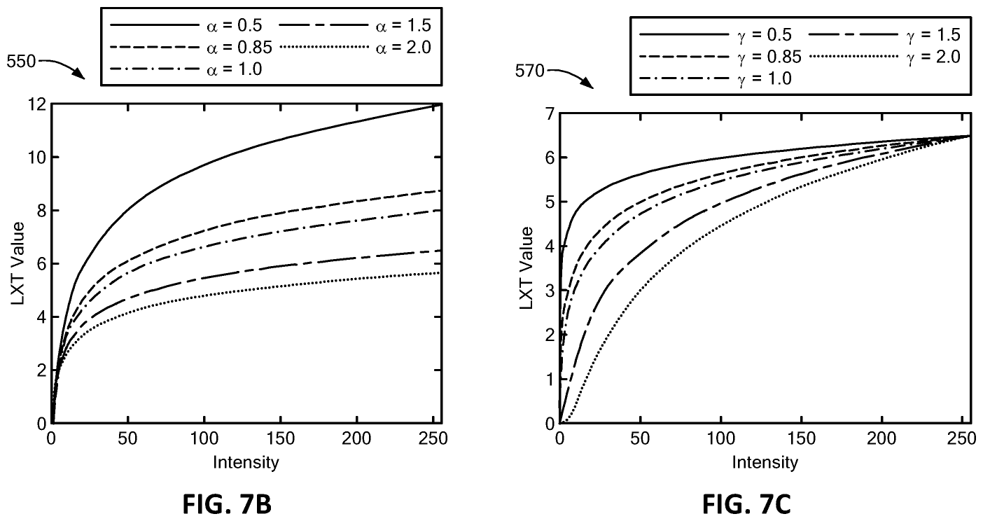

FIG. 7A shows the results 500 of the operation for various values of a, in accordance with the present disclosure. Row 1 is a visualization of the complete image, and rows 2 and 3 are the zoomed section of the image. Column (a) is the original image, (b) is the simulation of an over-exposed image where the darker regions are enhanced appropriately (α=2 and γ=0.75), and (c) is a simulation of an under-exposed image where the brighter regions are well-defined (α=0.5 and γ=1.75). Additionally, FIGS. 7B-7C show the results of the companding operation for various values of α and γ. As shown by graph 550, increasing a decreases the limit of higher intensity values and vice versa. Similarly, as shown by graph 570, increasing γ decreases the expansion of lower intensity values.

As mentioned above, the present disclosure includes a joint fusion of multi-block discriminative features, such as global and local features. Generally, local features define a portion of information about the image in a specific region or single point. In contrast, global features generally describe the entire image by considering all pixels in the image. The global features can provide information regarding the context of the entire image that can be integrated with local features to obtain visually pleasing results with lower artifacts. For image enhancement, the global features can determine the type of scene, subjects in the scene, and lighting conditions, among other things, to aid local adjustments in the image. Conversely, local features can represent the local texture or object at a given location.

The present DPIENet system can include a feature condense network (FeCN) (e.g., feature condense network 402) and a feature enhance network (FeEN) (e.g., feature enhance network 404). FeCN aims at producing local and global features. The local features are obtained through a series of layers, while the global features can be extracted from every layer of the condense network (i.e., rather than just the final layer). FeEN aims at reconstructing the enhanced image by exploiting skip connections from FeCN.

The feature condense network (FeCN) (e.g., feature condense network 402) can include feature groups, which can be denoted as Cₗ^{g}, where group g=1, 2, . . . ,8 and l indicates the number of the residual layer in that particular group and can range from 1,2, . . . ,n. For simplicity, the first feature extraction section is denoted by C⁰, and includes a convolutional (CONV) layer followed by batch normalization (BN) and scaled exponential linear unit (SELU) activation layers. This section can extract features from the image domain. The convolution (CONV) layer can employ a 3×3 kernel and produce 16 feature maps. The basic structure of the residual layer used in C¹⁻⁸ in the feature condense network can be seen in FIG. 6B, and is formulated in Equation 2:

Θₗ₊₁=S(I(Θₗ)+Ω(ωₗ*Θₗ+bₗ) |{ωₗ=[ω̅_{l,k}:k=1≤k≤K]} (2)

where Θₗ is the input feature map for the l^{th} residual layer, ωₗ, and bₗ are the associated set of weights and biases respectively, Ω denotes the combination of layers such as CONV→BN→SELU→CONV→BN, S denotes the SELU activation function, and I is the identity map. In groups C²⁻⁷, the first layer performs downsampling by striding instead of max pooling as it leads to high amplitude, high-frequency activations in the subsequent layers, which may increase gridding artifacts. For image enhancement techniques, downsampling may cause loss of spatial information; however, it allows for the reconstruction of the image with finer details.

Eliminating downsampling may increase resolution; however, it affects the receptive field in subsequent layers, thereby increasing context loss. To overcome this, dilated convolution is employed to adjust receptive fields of feature points without decreasing the resolution of feature maps. Dilated convolution can be used in all the layers in the group C⁵⁻⁷ instead of traditional convolution.

Furthermore, to increase the representative power of the global features in the network, the output of the last layer (κ) of each condense group from C⁰⁻⁸ can be connected to a global average pooling (GAP) layer. The GAP layer compresses the information of the residual layers making it more robust to the spatial translation. The outputs from each layer is concatenated, as shown in Equation 3:

γ_{fuse}=[Cₙ⁰;Cₙ¹;Cₙ², . . . , Cₙ⁸] (3)

These features generate a total of [Σᵢ₌₀^{B}ç(C_{K}ⁱ)×1×1] where ç is the number of channels/feature maps. The stacked feature maps are then fed into a dense layer D₁ which produces [{2×ç(C_{K}^{B)}×}1×1] output, followed by a SELU activation layer and another dense layer D₁ that produces [{ç(C_{K}^{B})}×1×1] global features. These are replicated to match the dimensions of Cₖ⁵. Thus, the dimensions of the replicated features are [128×32×32]. The joint fusion includes stacking the global features from D₁ and the local features from Cₖ⁵. This aids in incorporating global features into local features. Due to this way of concatenation, the network is independent of any input image resolution restrictions.

Once the local and global feature maps are concatenated, they can be fed to the feature enhance network (e.g., feature enhance network 404). The feature enhance network includes groups which can be denoted as Eₗ^{g}, where group g=0,1, . . . ,4 and l indicates the number of the residual layer in that particular group, and ranges from 1,2, . . . ,n. The feature layers of the condense and enhance network are symmetric to each other across the fusion block. Thus, if the condense group C² contains 2 residual layers, then E² also contains 2 residual layers.

In the case of the condense layer C⁰, E⁰ includes just one residual layer. Each enhance group in E^{g} mainly includes upsampling layers, compression layers, and residual layers. The input to each enhance group is the fusion of feature maps from the previous enhance group and the output of the corresponding condense group. This helps in propagating context information to higher resolution layers. The upsampling layer includes transposed convolutions with kernel size 2×2 and stride 2×2. This aids in increasing the resolution of the feature maps by a factor of 2.

The compressing layer provides CONV—BN—SELU, wherein the kernel size of CONV is 1×1. This is used to compress the feature dimensions by a factor of 2. The compressed feature maps are then fed to the residual layers for further processing. Finally, the output of the group E⁰ is connected to a CONV layer with kernel size 3×3, and residual learning is adopted by adding the input image to this layer.

As mentioned above, the present disclosure includes a dynamic channel attention (DCA) mechanism (e.g., DCA module 452). Most of the deep learning-based image enhancement techniques consider all the feature maps equally, which may not be correct in many real-world cases. Among the generated feature maps by the residual layers, few of the features might contribute more when compared to the rest. Moreover, the learned filters in the residual layers have a local receptive field, and each filter output exploits the contextual information outside of the subregion very poorly. Thus, a mechanism to recalibrate features can be implemented, such that more emphasis is provided for the feature maps with better mapping when compared to the less important feature maps.

One objective of this mechanism is to assign different values to various channels according to their interdependencies in each convolution layer. Thus, to increase the sensitivity of each channel, an intuitive way is to access the global spatial information by using average pooling over the entire feature map. The channel attention mechanism can be formulated, as shown in Equation 4:

$$Θ = σ ( {W}_{↑} ( S ( {W}_{↓} ( 1 / ( H \times W ) {\sum }_{m = 0}^{H - 1} {\sum }_{n = 0}^{W - 1} ( Φ ) ) ) + {b}_{↓} ) + {b}_{↑} ) \qquad ( 4 )$$

where Φ=[Φ1, Φ₂, . . . Φ_{c}] is the input feature map with c number of channels/feature maps and H×W dimensions, W↓[b↓] denotes weight [bias] of the compression convolution, which reduces the dimension by a factor of r, W↑[b↑] denotes weight [bias] of the expansion convolution, which increases the dimension by a factor of r, S denotes the SELU activation function, and σ is the sigmoid activation function.

The global average pooling (GAP) output can be realized as the fusion of local descriptors whose statistics express the entire feature map. The channel attention mechanism includes the convolutions with kernel size 1×1 along with the sigmoid activation. This aids in learning the nonlinear interaction between the channels and ensures that the multiple channels with more informative maps are emphasized. As the number of channels/feature maps in the condense and enhance networks keeps varying, the gating mechanism can be adjusted to accommodate these changes. The factor r is a hyperparameter, which varies the capacity of the gating mechanism. The ratio r was formulated as r=çⁱ/4 where çⁱ denotes the number of channels/feature maps at the input of the GAP layer.

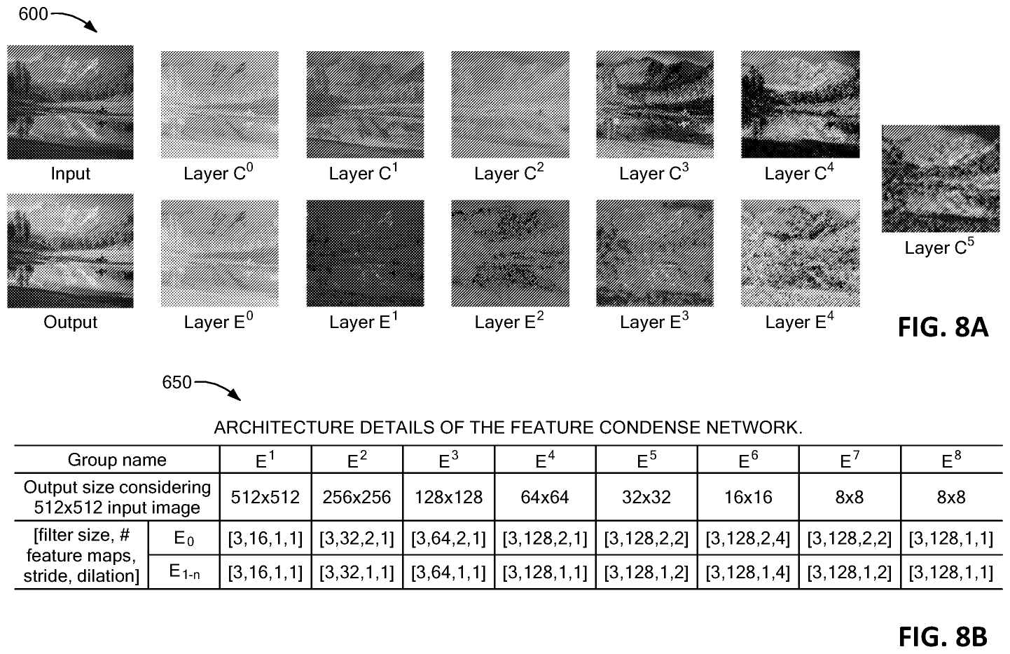

The feature maps generated at different layers are demonstrated in FIG. 8A. FIG. 8A includes a process 600, which shows a feature map from the output of each layer in the proposed network. FIG. 8B includes a table 650, which provides the parameters associated with each feature condense layer in FIG. 8A, according to embodiments of the present disclosure.

In some configurations, the DPIENet can include a multi-scale loss function. Several loss functions, such as L1, L2, cosine similarity measures, perceptual, and adversarial losses, have been investigated for various computer vision tasks.

A parametric based combination of these loss functions can be utilized as defined below:

L=γ₁Lₗ₁+γ₂L_{MS-SSIM}+γ₃L_{perc}+γ₄L_{adv}+γ₅L_{MHCV} (5)

where γ_{t;t=1,2,3 . . . 5} are the hyperparameter coefficients to balance between different losses. And where Lₗ₁—smooth L1 loss function, L_{MS-SSIM}—MS-SSIM loss function, L_{perc}—perceptual loss function, L_{adv}—adversarial loss function, L_{MHCV}—MS-MHCV loss function. The goal is to achieve enhanced images by minimizing the L.

Smooth L1 loss: The smooth L1 loss is defined as

(6)
${L}_{l 1} = \frac{1}{N} {\sum }_{i = 1}^{N} {L}_{smooth} ( {y}_{i} , f ( {x}_{i} , w ) )$
$where {L}_{smooth} ( {y}_{i} , f ( {x}_{i} , w ) = \{ \begin{matrix}\frac{0.5 {( y - f ( x , w ) )}^{2}}{beta} & if ( y - f ( x , w ) < beta \\ \begin{matrix}\vert y - f ( x , w ) \vert - \\ 0.5 * beta\end{matrix} & otherwise\end{matrix}$

Here y and x are the ground truth and hazy image at a pixel i.

Multi-Scale SSIM (MS-SSIM) loss may be defined as in (Zhao, Hang, Orazio Gallo, Iuri Frosio, and Jan Kautz. “Loss functions for image restoration with neural networks.” IEEE Transactions on computational imaging 3, no. 1 (2016): 47-57): In MS-SSIM loss assessment is performed on multiple scales of the reference and the distorted images. Lowpass filtering and down-sampling are applied iteratively, and elements of the SSIM loss are applied at each scale, indexed from 1 (original image) through the finest scale M obtained after M−1 iterations.

$${SSIM ( x , y )}_{i} = \frac{( 2 {μ}_{{x}_{i}} {μ}_{{y}_{i}} + {c}_{1} ) ( 2 {σ}_{{xy}_{i}} + {c}_{2} )}{( {μ}_{{x}_{i}}^{2} + {μ}_{{y}_{i}}^{2} + {c}_{1} ) ( {σ}_{{x}_{i}}^{2} + {σ}_{{y}_{i}}^{2} + {c}_{2} )} = {l}_{i} {cs}_{i} \qquad ( 7 )$$

where μₓ_{ᵢ}, μ_{y}_{₁} denote the mean along xᵢ, yᵢ respectively, σₓ_{ᵢ}, σ_{y}_{ᵢ} denote the standard deviation along xᵢ, yᵢ respectively. These are computed using a Gaussian filter with standard deviation σ_{G}_{ᵢ}, l(·) denotes the luminance contrast, and cs(·) refers to structure measures at scale M and j, respectively.

$${L}_{MM - SSIM} ( i ) = 1 - {l}_{M}^{α} ( i ) {\prod }_{j = 1}^{M} [ {cs}_{j}^{{β}_{j}} ( i ) ] \qquad ( 8 )$$

Perceptual loss may be defined as in (Johnson, J., Alahi, A., & Fei-Fei, L. (2016, October). Perceptual losses for real-time style transfer and super-resolution. In European conference on computer vision (pp. 694-711). Springer, Cham.) This loss provides additional supervision for reconstructing fine details that are pleasant to the human eye and comparing images in a feature space. The loss function is described as

$${L}_{perc} = \frac{1}{N} {\sum }_{j} \frac{1}{{C}_{j} {H}_{j} {W}_{j}} {‖ {ϕ}_{j} ( {f}_{θ} ( x ) ) - {ϕ}_{j} ( y ) ‖}_{2}^{2} \qquad ( 9 )$$

where x and y are hazy and ground truth images, respectively. ƒ_{θ}(x) is the dehaze image. ϕⱼ(·) denotes the feature map with size Cⱼ×Hⱼ×Wⱼ. The feature reconstruction loss is the L₂ loss, N—is the number of features used in the perceptual loss function.

Adversarial loss may be inspired by (Lucas, A., Lopez-Tapia, S., Molina, R., & Katsaggelos, A. K. (2019). Generative adversarial networks and perceptual losses for video super-resolution. IEEE Transactions on Image Processing, 28(7), 3312-3327.) The adversarial loss is defined based on the probabilities of the discriminator D(·) overall training samples as:

$${L}_{adv} = \frac{1}{N} {\sum }_{n = 1}^{N} - log {D}_{{θ}_{D}} ( {G}_{{θ}_{G}} ( x ) ) \qquad ( 10 )$$

where D_{θ}_{_{D}} (G_{θ}_{_{G}}(x)) is the probability that the reconstructed image G_{θG}(x) is a natural image. For better gradient behavior −log D_{θ}_{_{D}} (G_{θ}_{_{D}} (x)) is minimized.

Multiscale Human Color Vision Loss: The present disclosure includes a multi-scale loss function that works on the Retinex theory principle. According to this, the low-frequency information of the image represents the global naturalness and the high frequency information represents the local details. By decomposing the image into a low-frequency luminance component and a high-frequency detail component, the loss function incorporates both the local and global information. This loss is driven by the close to the logarithmic response of the human visual system (HVS) in large luminance range areas, which follows Weber-Fechner's law. In some embodiments, the multi-scale loss function described below can be implemented within the DPIENet.

The loss is constructed under the assumption that the image can be decomposed into illuminance and reflectance components. The illumination component [symbol] defines the global deviations in an image, while the reflectance [symbol] represents the details and colors. In combination, these components modulate the reconstruction of a perceptually enhanced image Pₑ= [symbol] ×

[symbol]

For simplicity of exposition, consider the case in which the loss function consists of a single scale: the extension to multiple scales is straightforward. Consider a predicted image I and ground truth image T of any arbitrary size (m, n). The log based illumination component is constructed by employing a center/surround algorithm. The algorithm may comprise of but not limited to alpha trimmed Gaussian filter [symbol] _{σ}, which can be formulated, as shown in Equation 11:

$${ℒ}_{σ}^{Ψ} = log ( {𝒢}_{σ} ⊗ {Ψ}^{2} ) σ ∈ \{ 0.5 , 1 , 2 , 4 , 8 \} \\ where {trim ( {𝒢}_{σ} )}_{α} = \frac{1}{2 {πσ}_{α}^{2}} {e}^{- \frac{{x}^{2} + {y}^{2}}{2 {σ}_{α}^{2}}} \qquad ( 11 )$$

where ⊗ denotes convolution and for the illumination component of predicted image Ψ takes the value of I and Ψ=T for ground truth image.

The value of a cannot be theoretically modeled and determined. The choice of right scale a for the surround filter is important for single scale retinex. This can be overcome by utilizing the multi scale retinex which seems to afford an acceptable trade-off between a good local dynamic range and a good color rendition. Thus, empirically, the σ values were set to 0.5, 1, 2, 4, and 8. The log based reflectance component is constructed by taking the difference between the image and illumination component. This can be formulated, as shown in Equation 12. The resulting multiscale human color vision (MEICV) loss function using these two components can be defined, as shown in Equation 13.

$${ℛ}_{σ}^{Ψ} = log ( {Ψ}^{2} ) - {ℒ}_{σ} \qquad ( 12 )$$

$$MHCV = \frac{1}{N} {\sum }_{i = 1}^{N} [ \frac{α}{n} {\sum }_{j = 1}^{n} {( {ℒ}_{{σ}_{i} , j}^{T} - {ℒ}_{{σ}_{i} , j}^{I} )}^{2} + \frac{1 - α}{n} {\sum }_{j = 1}^{n} {( {ℛ}_{{σ}_{i} , j}^{T} - {ℛ}_{{σ}_{i} , j}^{I} )}^{2} ] \qquad ( 13 )$$

$$N = dim ( σ ) ; α = 0.5$$

Variable weight can be provided to both illumination and reflectance components as both global variations of illuminance and local colors and details are useful for the successful reconstruction of enhanced images.

### Experimental Results

This section provides the performance evaluation of a DPIENet system including a NIE, in accordance with the embodiments described herein. After outlining the experimental settings, chosen datasets, and training details, performance comparisons with existing methods are provided to demonstrate the effectiveness and generality of the presently disclosed systems and methods.

For training, validation, and testing purposes, the MIT-Adobe FiveK dataset is employed. This dataset contains 5,000 photographs taken with single-lens reflex (SLR) cameras by different photographers. These photographs covered a broad range of scenes, objects, subjects, and lighting conditions. Each image was retouched by five well-trained photographers using global and local adjustments. Among these retouchers, the result of photographer “C” was selected as ground truth, because the photographs received a high rank among users. The untouched images were considered as input images. This consisted of images with standard exposure (Λₛ) and low exposure (Λ_{L}). The dataset was split into three partitions: 4,000 images for training, 500 images (250 low+250 standard exposure) for validation, and testing. All the images from this dataset were downsized to 512 along the long side for training, validation, and testing purposes.

For training, color (RGB) input patches of size 256×256, along with the corresponding ground truth was considered. The training data was augmented using random horizontal, vertical, and 90-degree rotations along the center of the image.

To stabilize the network, the standard deviation was set to √(0.1/n). For training the model, AdaBound optimizer with β₁=0.9, β=0.999, ε=1×10⁻⁸ and γ=1×10⁻³ was employed. The batch size was set to 20. The learning rate was initialized as 1e⁻³ and the final learning rate was initialized as 0.1. The network was trained for a total of 2.85×10⁶ updates and multistep learning rate scheduler was used to decrease the learning rate by 0.1 at 9.5×10⁵, 1.9×10⁶ and 2.375×10⁶ iterations. For training, the proposed multi-scale human vision loss was employed instead of L1 and L2 loss. Minimizing L2 is generally preferred as it maximizes the peak signal-to-noise ratio (PSNR). However, based on a series of experiments conducted, MHCV loss provides better convergence than L1 or L2 loss.

DPIENet was compared with other state-of-the-art algorithms (SOTA) using measures such as PSNR, structural similarity index measure (SSIM), gradient-based structural similarity index measure (GSSIM), and universal quality measure (UQI). These measures are applied to all the RGB channels of the image. All of these measures access the image quality based on the given reference benchmark image that is assumed to have the desired quality. Higher quality value depicts how close the enhanced images are to the ground truth.

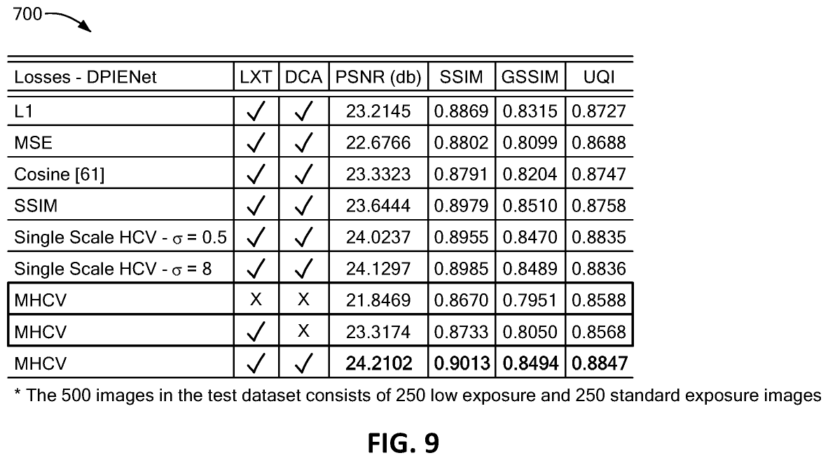

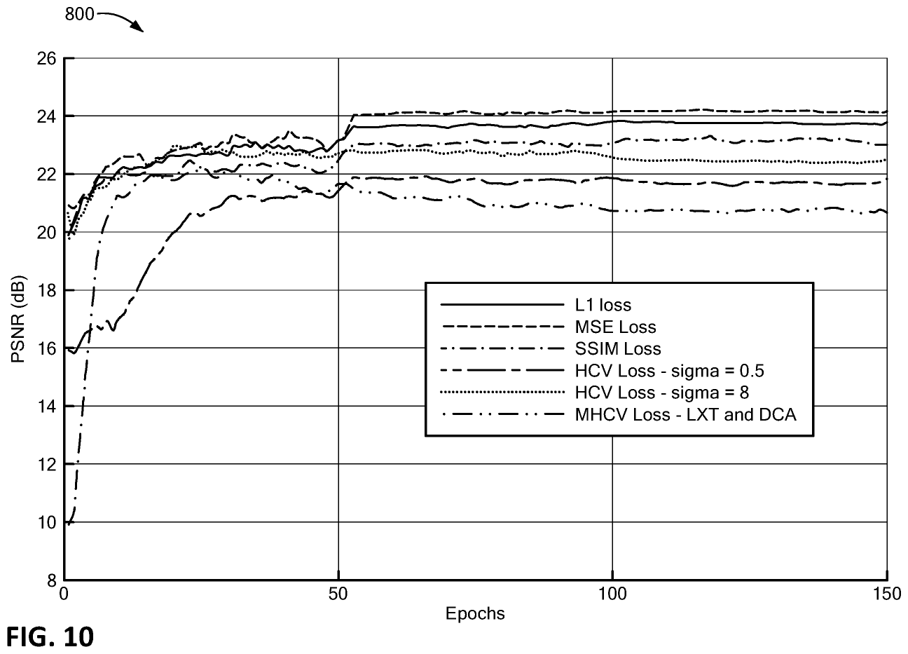

The ablation tests included experiments exploring different designs and exposure settings. The quantitative performance of different models is provided by table 700 in FIG. 9. When the NIE (e.g., LXT) and DCA mechanisms are removed from the network, the performance is relatively low. For example, in terms of PSNR, DPIENet without LXT and DCA reaches 21.84 dB; when LXT is added, the performance increases to 23.31 dB. FIG. 10 provides a graph 800 which illustrates the results found in the table 700.

Still referring to FIGS. 9 and 10, the effectiveness of DPIENet with MHCV loss is demonstrated. A comparison with existing losses such as L1, L2, SSIM, Cosine, and single scale human color vision (HCV) loss is provided in the table 700. This was obtained by applying PSNR on 500 images (a combination of both low and standard exposure) from the validation set. The curves shown in the graph 800 indicate MHCV loss with NIE (e.g., LXT), and DCA has superior performance. It can be inferred that MHCV loss outperforms with a higher margin of improvements when compared to L1 and L2 loss. The single scale HCV loss performs fairly, however PSNR fluctuates for each scale, for example when σ=0.5, PSNR is 24.02 and when σ=0.5, PSNR is 24.12. To overcome this variation, multiple sigma levels in MHCV is utilized and it performs slightly better than the single scale HCV loss.

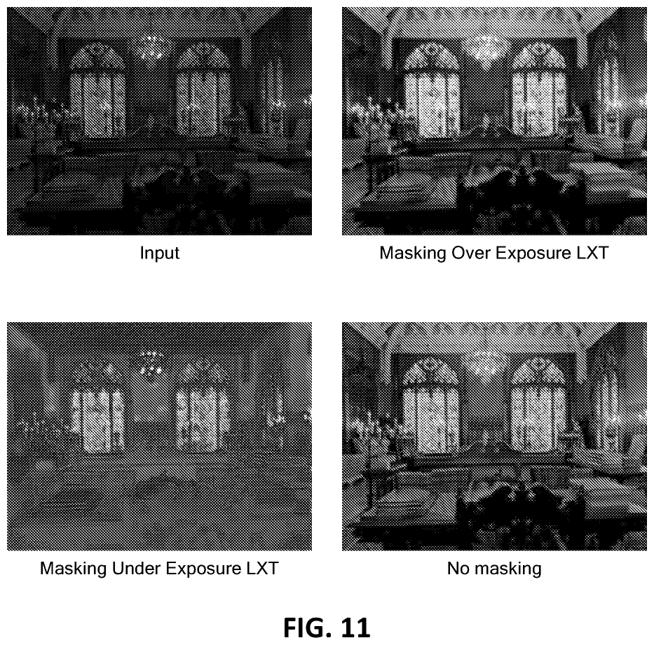

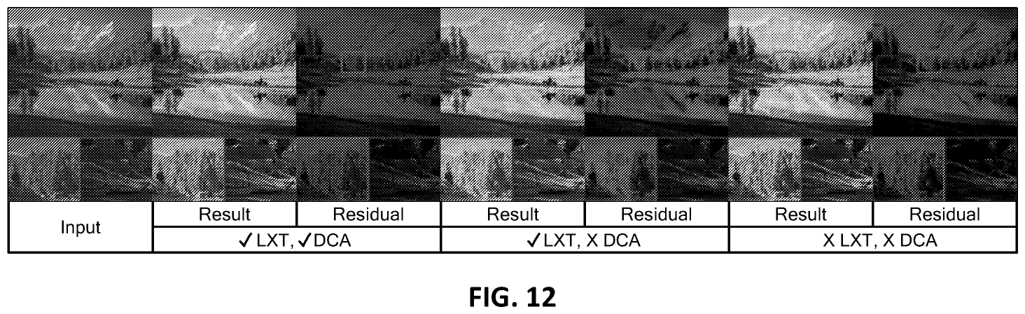

To understand the contribution of each of the synthetic NIE (e.g., LXT) images, an illustration is shown in FIG. 11. Masking the output of an individual synthetic image causes the output to change, depending on which image was masked and thus emphasizing its contribution to the overall system. By masking the overexposure LXT, the resulting image has more detail in the dark regions, whereas by masking the underexposure LXT, the brighter areas of the image are enhanced. Finally, when both the synthetic images are used, the resulting output enhances both the bright and the dark regions. When both LXT and DCA are combined, it reaches 24.21 dB. This indicates that the presently disclosed LXT+DCA mechanism, along with stacking, is much more powerful than the residual block-stacking method and gives a boost in performance roughly by a factor of 2.3 dB. This can be visually observed by extracting the residual feature map, as shown in FIG. 12.

Referring to FIG. 12, the feature map displayed is the residual layer, which is added to the original image. Without LXT and DCA, the residual layer has learned minimal information, which is depicted by the final result. The trees have a yellow tint, and the dark region is still dark. Upon adding NIE (e.g., LXT), the trees have much better contrast, and the dark region is visually improved. However, on adding both these components, the trees have much better contrast, and the dark region is optimally enhanced. The zoomed view shows the intensity variations among the different models.

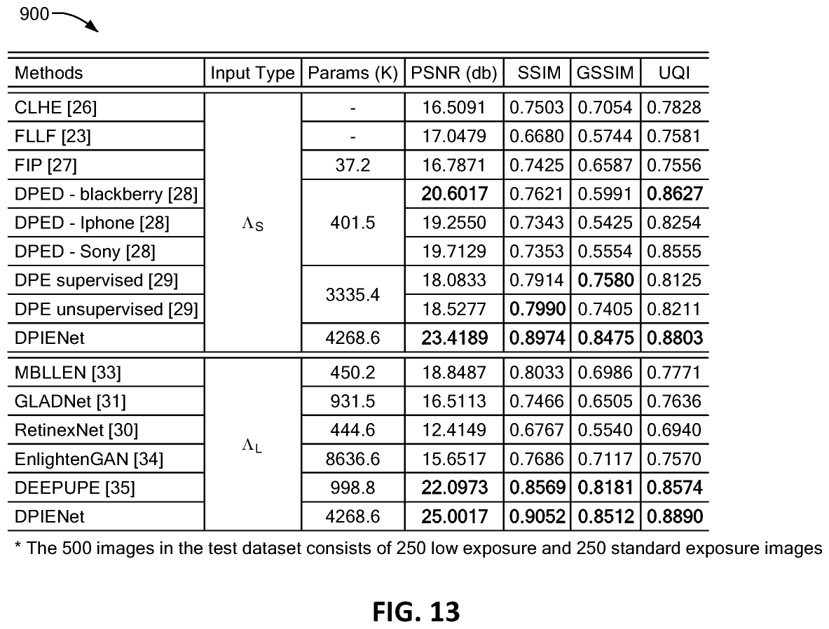

The presently disclosed network is compared with known methods for standard and low exposure settings. For standard exposure input setting, several recent methods such as contrast limited histogram equalization (CLHE), fast local laplacian filter (FLLF), deep photo enhancer (DPE) supervised and unsupervised, DSLR photo enhancement dataset (DPED) trained with Blackberry, Iphone, and Sony images, and fast image processing (FIP) were considered. Table 900 in FIG. 13 demonstrates that DPIENet performs significantly better when compared to the other methods.

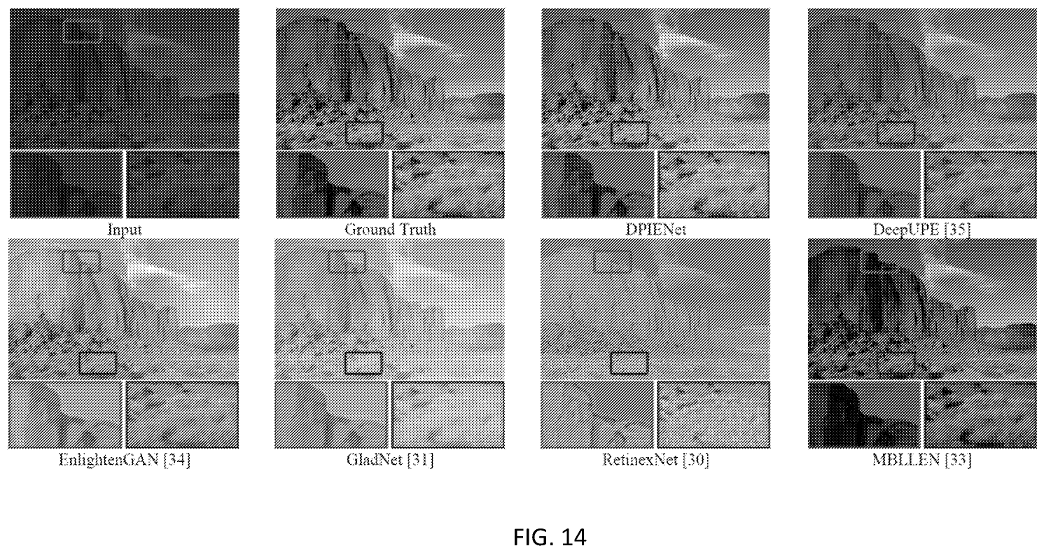

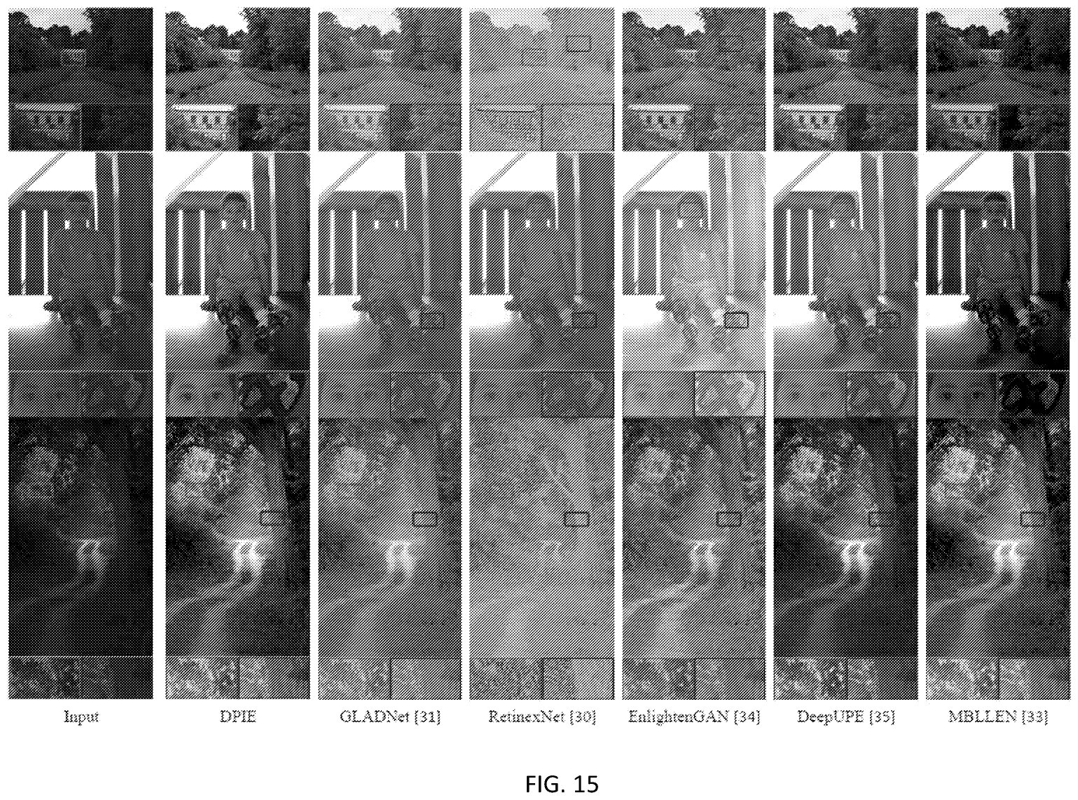

The quantitative results for low exposure settings are provided in table 900. This indicates that the images are restored with superior quantitative performance. A visual comparison of this setting is illustrated in FIG. 14 (with ground truth) and FIG. 15 (real world).

Referring to FIG. 14, zoom-in regions are used to illustrate the visual difference. Underexposed Photo Enhancement using Deep Illumination Estimation (DeepUPE) generates an image with a soft haze effect; multi-branch low-light enhancement network (MBLLEN) produces dark images. Deep light enhancement without paired supervision (EnlightenGan), low-light enhancement network with global awareness (GladNet) introduces a foggy effect. However, DPIENet restores details but also avoids various artifacts and provides results similar to the ground truth.

Referring to FIG. 15, zoom-in regions are again used to illustrate the visual difference. In the first example, DPIENet produces visually pleasing realistic colors. DeepUPE and MBLLEN do produce realistic colors; however, they introduce exposure artifacts. In the second example, DPIENet produces images with better details (see zoomed shoe). In the third example, DPIENet provides better visible details and color, as shown by the zoomed regions. Overall, EnlightenGAN and RetinexNet tend to produce unrealistic colors. GLADNet introduces hazy effect, and DeepUPE and MBLLEN suffer from exposure-related artifacts.

In view of the above, the DPIENet system was able to reconstruct a visually pleasing image close to the ground truth and mimic human perception while retaining natural color rendition. In comparison, the other techniques contain exposure artifacts, and the colors are less perceptually similar when compared to the ground truth.

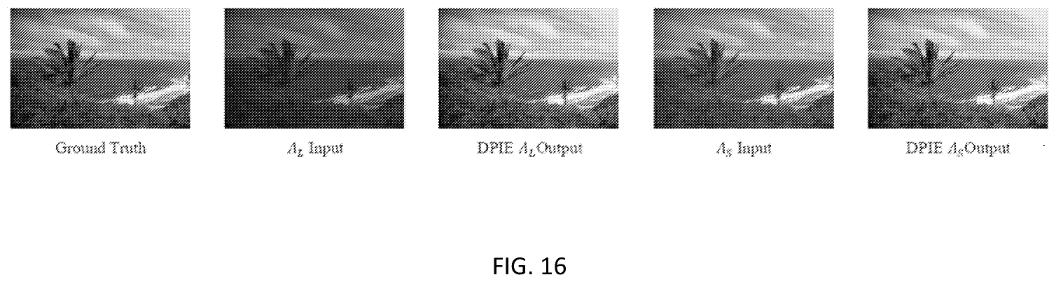

The present model is additionally compared with the most recent deep learning based low light image enhancement techniques, such as MBLLEN, EnlightenGAN, DEEPUPE, GLADNet, and RetinexNet. The present network reconstructs perceptually improved images that have a higher correlation with the ground truth when compared to the other models. An illustrative example to show the robustness of the model in handling various kinds of input is displayed in FIG. 16. As shown by FIG. 16, for both low exposure input and standard exposure input, the output of the model is very similar to each other and close to the ground truth.

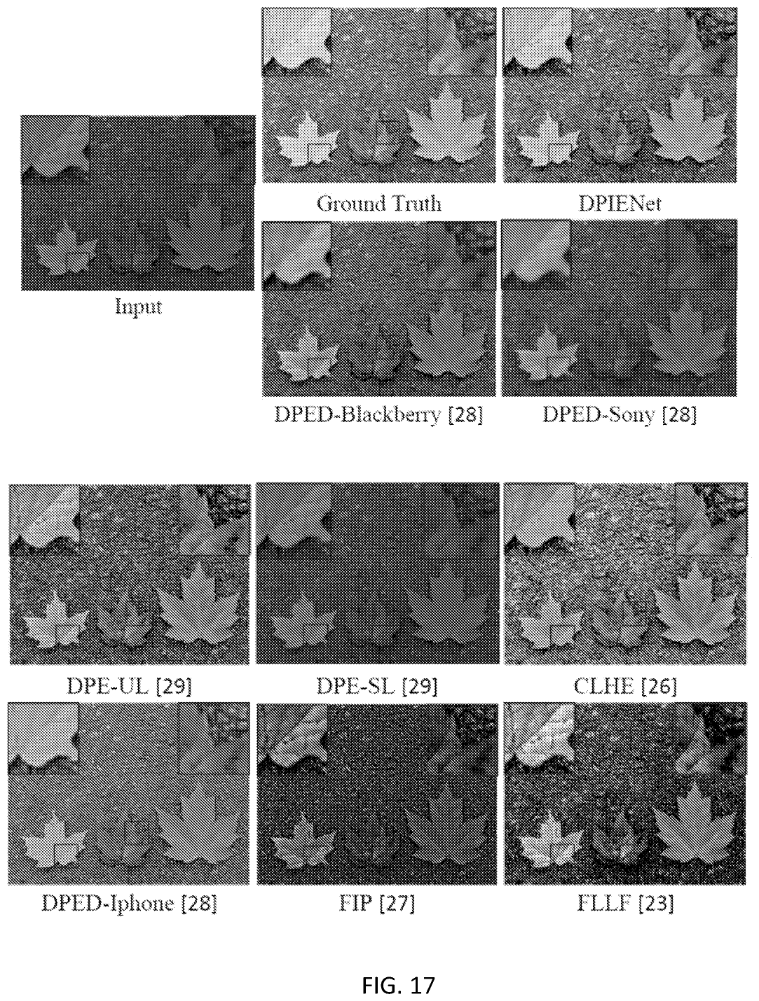

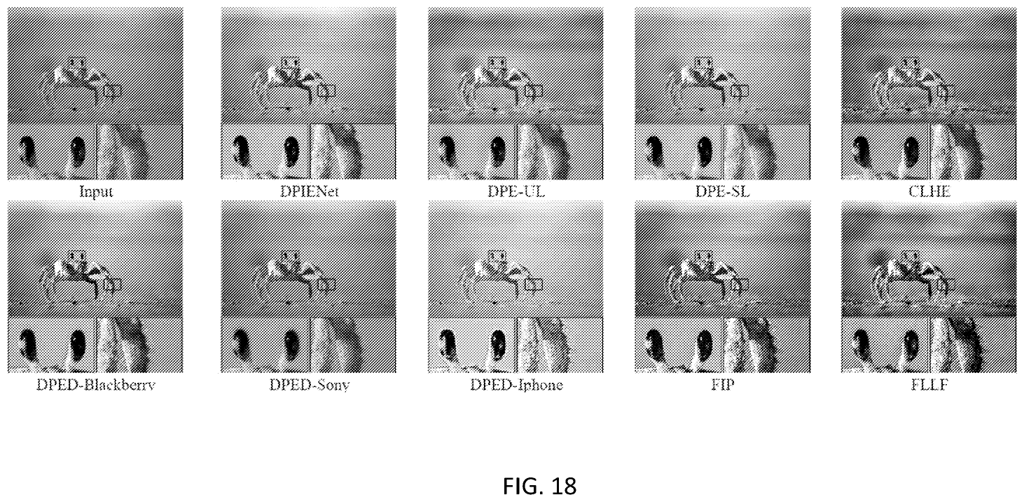

Additional visual comparisons are provided in FIGS. 17-20. FIG. 17 illustrates that the enhanced colors of the DPIENet are very similar to the ground truth, while FIGS. 18-20 provide results of a few real-world examples. The zoomed regions in the images demonstrate the color and edge-preserving property of DPIENet compared to existing techniques, which tend to over-saturate, introduce variations in color, and induce blurriness.

Referring specifically to FIG. 17, DPIENet not only restores the details but also avoids discoloration. The other techniques tend to exhibit artifacts such as variation in color (for example, DPE-UL tends to shift the color towards orange from red, DPED-Blackberry introduced green color), over enhancement (for example, FLLF and FIP over enhance the details which look dark), and blurriness (for instance, the DPED-Sony image appears smoothed).

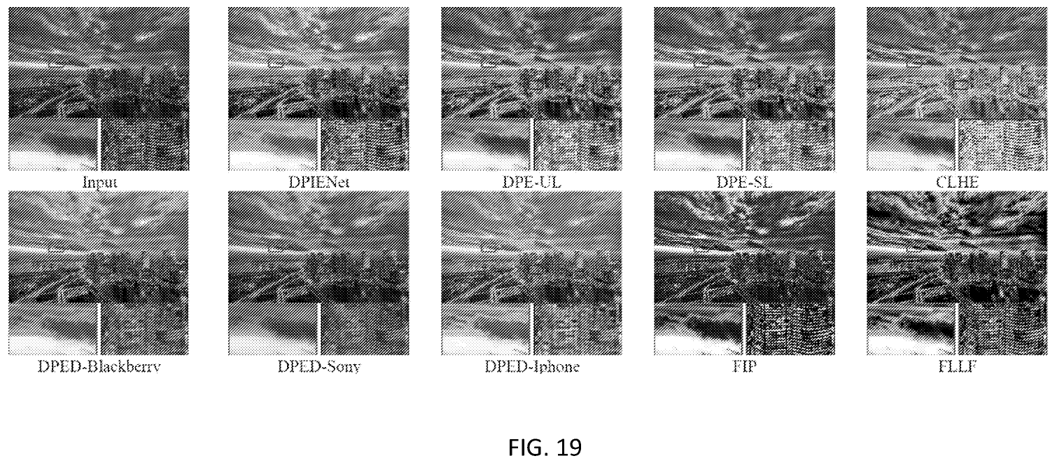

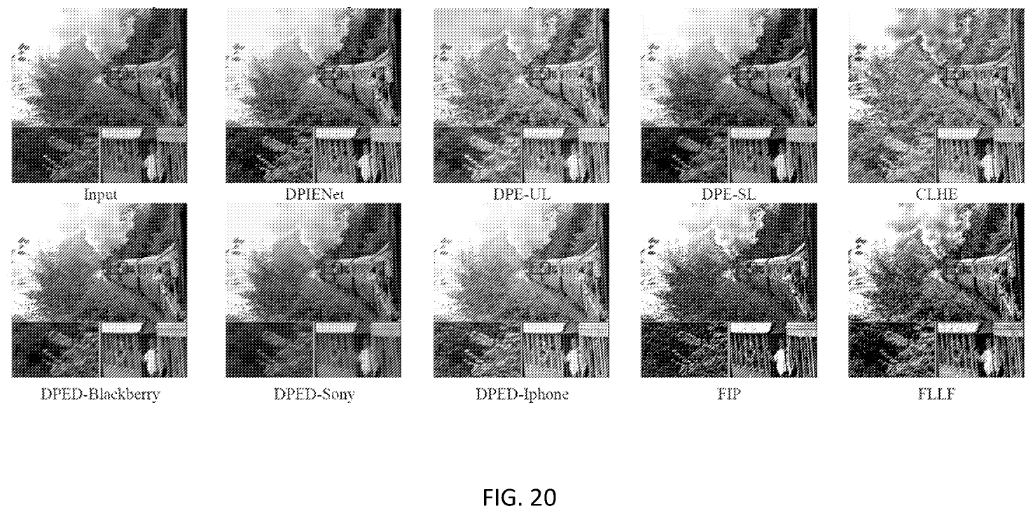

In FIG. 18, DPIENet successfully suppresses the noise, which is visible in CLHE, FIP, and FLLF. Furthermore, it does not have halo artifacts that are introduced by DPE-UL and DPED. As shown in FIG. 19, the building's structural details are preserved compared to DPE-UL and CLHE. In FIG. 20, the color of the leaves is preserved when compared to the other techniques. DPE-UL has introduced blue sky, which is not present in the input, and the leaves are yellow. In all the examples, DPED introduces blurring, and FIP and FLLF generate under-exposed/ darker images.

The present systems and methods utilize DPIENet to successfully enhance a variety of input images. DPIENet can be configured for multi-exposure simulation using logarithmic exposure transformation. The disclosed end-to-end mapping approach includes both feature condense and feature enhance networks, which can leverage the idea of residual learning to reach larger depth. Furthermore, the skip connection between these networks can aid in recovering spatial information while upsampling.

To improve the ability of the network to realize the context of the image, global features can be exploited from each group in the condense network. To further boost the channel interdependencies of the network, a dynamic channel attention mechanism to adaptively rescale channel-wise features can be employed. Additionally, to obtain realistic images which correlate to human vision, a multi-scale human vision (MSHV) loss is disclosed. The MSHV loss, and associated training of the neural network, can aid in accounting for the global variation in illumination, details, and colors.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., RAM/ROM, CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array), a general purpose graphical processing units (GPGPU), and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A system for training a neural network, the system comprising:
a neural network configured to receive a training input in an image space and produce an enhanced image;
an error signal generator configured to compare the enhanced image to a ground truth and generate an error signal that is communicated back to the neural network to train the neural network; and
a neural input enhancer configured to modify the training input in response to receiving at least one of an output from the neural network or the error signal, wherein modifying the training input improves one of an efficiency or a training result of the neural network beyond the communication of the error signal to only the neural network.

2. The system of claim 1, wherein the neural input enhancer receives the output from the neural network, the output associated with updated parameters within the neural network.

3. The system of claim 1, wherein the neural input enhancer receives the error signal, the neural input enhancer configured to modify the training input independently of updated parameters within the neural network.

4. The system of claim 1, wherein the output from the neural network is determined via reverse sequential calculation and storage of gradients of intermediate variables and parameters within the neural network.

5. The system of claim 1, wherein the error signal generator is configured to generate the error signal based on illuminance and reflectance components of the training input.

6. The system of claim 5, wherein the error signal provides equal weight to the illuminance and reflectance components of the training input.

7. The system of claim 1, wherein the error signal generator is configured to generate the error signal in the image space.

8. The system of claim 1, wherein the neural network is configured to produce the enhanced image in a feature space.

9. A method of training a system for image enhancement, the method comprising:
providing a training input to a neural network via a neural input enhancer;
generating an enhanced image from the training input;
comparing the enhanced image to a ground truth and generating an error signal;
providing the error signal to the neural network;
receiving, at the neural input enhancer, at least one of an output from the neural network or the error signal; and
modifying the training input based on the at least one of the output from the neural network or the error signal,
wherein modifying the training input improves one of an efficiency or a training result of the neural network beyond communication of the error signal to only the neural network.

10. The method of claim 9, wherein modifying the training input occurs in an image space.

11. The method of claim 9, wherein generating the enhanced image occurs in a feature space.

12. The method of claim 9, wherein generating the error signal comprises determining illuminance and reflectance components of the training input.

13. The method of claim 12, wherein the error signal provides equal weight to the illuminance and reflectance components of the training input.

14. The method of claim 9, further comprising generating the output from the neural network by:
performing a reverse sequential calculation for the neural network; and
storing gradients of intermediate variables and parameters within the neural network.

15. The method of claim 9, wherein the neural input enhancer receives the output from the neural network, the output associated with updated parameters within the neural network.

16. The method of claim 9, further comprising modifying the training input independently of updating parameters within the neural network.

17. A method of enhancing images, comprising:
receiving an input image;
adjusting an exposure range of the image, including synthetically changing exposures of brighter and darker regions of the image to generate an exposure-adjusted image;
determining discriminative features for the exposure-adjusted image; and
combining the discriminative features to generate an enhanced image.

18. The method according to claim 17, further including applying a loss function to the enhanced image to generate a perceptually enhanced image, wherein the loss function processes illuminance and reflectance components of the enhanced image.

19. The method according to claim 17, wherein adjusting the exposure range of the image comprises logarithmic exposure transformation (LXT) processing.

20. The method according to claim 17, wherein synthetically changing exposures of brighter and darker regions of the image includes generating synthetic images having under-exposed images with bright regions that are well-defined with contrast, and over-exposed images with finer details in dark and shadow areas highlighted.

21. The method according to claim 17, wherein the discriminative features define a portion of information about the exposure-adjusted image and an entirety of the exposure-adjusted image.

22. The method according to claim 21, further including integrating first ones of the discriminative features to determine a type of scene, subjects in the scene, and/or lighting conditions, and second ones of the discriminative features represent local texture or object at a given location in the exposure-adjusted image.

23. The method according to claim 17, further including employing a feature condense network and a feature enhance network to determine the discriminative features.

24. The method according to claim 23, wherein the feature condense network and the feature enhance network generate feature maps having channels, and further including assigning different values to different ones of the channels according to convolution layer interdependencies.

25. The method according to claim 18, wherein the illumination component defines global deviations in the enhanced image and the reflectance component represents details and colors of the enhanced image.

26. The method according to claim 25, wherein the illumination component and the reflectance components are equally weighted.

27. A system, comprising:
a processor and a memory configured to:
receive an input image;
adjust an exposure range of the image, including synthetically changing exposures of brighter and darker regions of the image to generate an exposure-adjusted image;
determine discriminative features for the exposure-adjusted image; and
combine the discriminative features to generate an enhanced image.

28. The system according to claim 27, wherein the processor and the memory are further configured to apply a loss function to the enhanced image to generate a perceptually enhanced image, wherein the loss function processes illuminance and reflectance components of the enhanced image.

29. The system according to claim 27, wherein adjusting the exposure range of the image comprises logarithmic exposure transformation (LXT) processing.

30. The system thod according to claim 127, wherein synthetically changing exposures of brighter and darker regions of the image includes generating synthetic images having under-exposed images with bright regions that are well-defined with contrast, and over-exposed images with finer details in dark and shadow areas highlighted.

31. The system according to claim 27, wherein the discriminative features define a portion of information about the exposure-adjusted image and an entirety of the exposure-adjusted image.

32. The system according to claim 31, wherein the processor and the memory are further configured to integrate first ones of the discriminative features to determine a type of scene, subjects in the scene, and/or lighting conditions, and second ones of the discriminative features represent local texture or object at a given location in the exposure-adjusted image.

33. The system according to claim 27, wherein the processor and the memory are further configured to employing a feature condense network and a feature enhance network to determine the discriminative features.

34. The system according to claim 33, wherein the feature condense network and the feature enhance network generate feature maps having channels, and further including assigning different values to different ones of the channels according to convolution layer interdependencies.

35. The system according to claim 28, wherein the illumination component defines global deviations in the enhanced image and the reflectance component represents details and colors of the enhanced image.

36. The system according to claim 35, wherein the illumination component and the reflectance components are equally weighted.
